(19) United States
(12) Patent Application Publication
(10) Pub. No.: US 2013/0144677 A1
(43) Pub. Date: Jun. 6, 2013

(54) WORKFLOW AUTOMATION SYSTEM AND METHOD FOR CONSTRUCTION INDUSTRY

(71) Applicant: OCSS LLC, San Diego, CA (US)

(72) Inventor: Nancy Ellen Tuggle, San Diego, CA (US)

(73) Assignee: OCSS LLC, San Diego, CA (US)

(21) Appl. No.: 13/705,117

(22) Filed: Dec. 4, 2012

Related U.S. Application Data
(60) Provisional application No. 61/567,037, filed on Dec. 5, 2011.

(51) Int. Cl. G06Q 40/00

(52) U.S. Cl. CPC G06Q 40/10
USPC 705/7.23

(57) ABSTRACT

Systems and methods are provided that enable users in the building trades to project costs and to monitor invoicing and funding in real time, thereby cutting back on back office staff and allowing contractors to accurately project cash flow.

### CROSS-REFERENCE TO RELATED APPLICATION

This application claims the benefit of U.S. Provisional Application Ser. No. 61/567,037 filed Dec. 5, 2011, the disclosure of which is hereby expressly incorporated by reference in its entirety and is hereby expressly made a portion of this application.

### FIELD OF THE INVENTION

Systems and methods are provided that enable users in the building trades to project costs and to monitor invoicing and funding in real time, thereby cutting back on back office staff and allowing contractors to accurately project cash flow.

### BACKGROUND OF THE INVENTION

An unprecedented 57 Percent of the 10.3 million licensed contractors in the United States fail within their first four years. The reasons can include poor implementation of legal documentation and project costing procedures, over-staffing and the inability to project cash flow.

While various software programs are targeted to the construction industry, there is no software that considers the perspective of the property owner and none that address all concerns related to implementation of legal documentation, project costing procedures, over staffing, and projection of cash flow. For example, QuickBooks contractor edition, available from Intuit, Inc. of Mountain View, Calif., is strictly financial accounting software and does not address the flow of legal documents nor does it assist in communication and integration of all of the procedures necessary to construction projects. Certain companies may provide project management software that does address paper flow, but is very expensive, difficult to use and does not link all aspects of the project together.

### SUMMARY OF THE INVENTION

With more than 5 million contractors losing their companies and livelihood, systems and methods that provide for clear communication and procedures in the building trades is desirable.

Accordingly, systems and methods of certain embodiments are provided that enable those in the building trades to project costs and to monitor invoicing and funding in real time, thereby cutting back on back office staff and allowing contractors to accurately project cash flow.

The systems and methods of certain embodiments can facilitate validating licenses of contractors and sub-contractors, an otherwise time consuming task. In most states it is illegal to utilize an unlicensed contractor, and the penalties and fines from Worker Compensation for doing so are staggering to a small to mid-size company. Accordingly, systems and methods that enable licenses to be immediately verified with the contractor state license board, for protection, are desirable.

A system and/or method for attaining one or more of the above-referenced objectives are provided. The Contractors Trust System (CTS) is fully automated and interactive software for the construction industry. It is a visually dynamic and user-friendly system that standardizes and streamlines the creation and transmission of legal and insurance documents, project costing, invoicing and milestone funding between the contractors, sub trades, suppliers and property owners.

There are 10.3 million licensed general and trade contractors in the United States, grossing $789 Billion in revenue for the construction industry. There are also 194 million property owners that have commercial or multi residential properties, and there are also homeowners that want to easily monitor the construction process. Due to the difficulties in securing mortgages for new properties, the market has seen a 20% increase in home remodeling this year alone with projected increases of an additional 16% annually for the next 4 years. These property owners are looking for a way to interface with their contractor and subcontractors while protecting their homes and saving money. CTS can enable these users to achieve one or more of these objectives.

In a first aspect, a method is provided for managing a construction project, comprising: inputting a user's personal data into a contractors trust system, wherein the personal data includes licensing information for a user; inputting project data into the contractors trust system, wherein the project data includes a contract amount; inputting cost information for the project; inputting funding information for the project, wherein the funding information includes approval or declining of an invoice; saving the inputted data; verifying license information with a licensing agency; generating legal documents and automatically submitting them to a preselected party; and graphically displaying estimated costs and actual costs for the project in real time.

In an embodiment of the first aspect, verifying license information further comprises providing the user confirmation of a valid license.

In an embodiment of the first aspect, the method further comprises generating a reminder for renewing a user's license with a licensing board, wherein license information has been entered for the license.

In an embodiment of the first aspect, the method further comprises entering a change order that is immediately incorporated into the estimated costs.

In an embodiment of the first aspect, the method further comprises creating an invoice based on the cost information and automatically submitting the invoice for payment at a preselected time based on the cost information.

In an embodiment of the first aspect, the method further comprises submitting an invoice for payment upon approval, whereby automatic electronic payment of the invoice is initiated using financial information included in the personal data.

In a second aspect, a user device is provided comprising: a processor; and a memory adapted to store a plurality of machine-readable instructions which when executed by the processor are adapted to cause the user device to accept input of a user's personal data into a contractors trust system, wherein the personal data includes licensing information for a user; accept input of project data into the contractors trust system, wherein the project data includes a contract amount; accept input of cost information for the project; accept input of funding information for the project, wherein the funding information includes approval or declining of an invoice; save the inputted data; verify license information with a licensing agency; generate legal documents and automatically submit them to a preselected party; and graphically display estimated costs and actual costs for the project in real time.

In an embodiment of the second aspect, the machine-readable instructions when executed by the processor are adapted to further cause providing the user confirmation of a valid license.

In an embodiment of the second aspect, the machine-readable instructions when executed by the processor are adapted to further cause generation of a reminder for renewing a user's license with a licensing board, wherein license information has been entered for the license.

In an embodiment of the second aspect, the machine-readable instructions when executed by the processor are adapted to further cause entry of a change order that is immediately incorporated into the estimated costs.

In an embodiment of the second aspect, the machine-readable instructions when executed by the processor are adapted to further cause creation of an invoice based on the cost information and automatic submission of the invoice for payment at a preselected time based on the cost information.

In an embodiment of the second aspect, the machine-readable instructions when executed by the processor are adapted to further cause submission of an invoice for payment upon approval, whereby automatic electronic payment of the invoice is initiated using financial information included in the personal data.

In a third aspect, a non-transitory computer readable medium is provided having computer readable code for instructing a processor to perform a method, the method comprising: inputting a user's personal data into a contractors trust system, wherein the personal data includes licensing information for a user; inputting project data into the contractors trust system, wherein the project data includes a contract amount; inputting cost information for the project; inputting funding information for the project, wherein the funding information includes approval or declining of an invoice; saving the inputted data; verifying license information with a licensing agency; generating legal documents and automatically submitting them to a preselected party; and graphically displaying estimated costs and actual costs for the project in real time.

### BRIEF DESCRIPTION OF THE DRAWINGS

FIG. 1 depicts the main screen of the CTS software, or Project Dashboard.

FIG. 2 depicts a menu of available screens, including Project Driver, Project Profile, Project Costing, Project Funding, and Doc Dock.

FIG. 3 depicts the Project Driver screen prior to entry of data.

FIG. 4 depicts the Project Driver screen after saving entered data.

FIG. 5 depicts a portion of the Project Driver screen relating to information regarding professional licenses.

FIG. 6 depicts a portion of the Project Driver screen relating to professional references.

FIG. 7 depicts the Project Profile Screen.

FIG. 8 depicts an interface on the Project Profile Screen that enables the user to invite a new user to the project.

FIG. 9 depicts an interface on the Project Profile Screen that enables the user to add an invitee to the project.

FIG. 10 depicts the Project Profile screen after data has been entered and saved.

FIG. 11 depicts the Project Costing screen.

FIG. 12 depicts the Project Funding screen.

FIG. 13 depicts details of the Project Funding screen relating to invoice information.

FIG. 14 depicts the Doc Dock screen.

FIG. 15 depicts a document accessed and displayed via the Doc Dock screen.

### DETAILED DESCRIPTION OF THE PREFERRED EMBODIMENT

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

The Contractors Trust System (CTS) provides a user the tools to attain a fully automated, interactive and successful project management. By utilizing CTS's clear user friendly features, the flow of information, legal and insurance documents, project costing and milestone funding from the property owner to contractors, sub trades and suppliers is streamlined and automated. This insures that all parties are protected and have a clear understanding of what is required to complete the project on schedule, and within budget. The Project Driver and Project Profile screens are where all pertinent information is entered. This information auto populates the necessary legal and financial documents. As the property owner, a user is asked to invite their contractor and sub trades, who are then able to download the CTS software. As a contractor, a user's license is automatically verified and entered into a nationwide database as a registered user of the CTS system, enabling other users to access the user's licensing information. Tools for easily and accurately following the flow money on a project are one of the advantageous features of CTS. At Project Costing, the system uploads a breakdown of all costs from a user's contractors and populates all invoices, funding and releases. On the money gauges, a user is able to monitor all project costs versus the budget in real time. The Doc Dock is where all documents are stored. State specific legal documents required for the user's protection are generated and submitted to the appropriate parties. Clear signals identify what insurance or releases have not been received, and invoicing and funding are made simple based on the milestones funding system. With one click, the user can approve or, if necessary, decline an invoice. Approved invoices are placed on the easy to read calendar, affording contractors the ability to project cash flow. For the contractor user, milestone funding eliminates the problem of delays and the need to make tedious collection calls. By using CTS, all parties involved in a project have a variety of options in which to pay for the project. All banking and personal information are both protected and secure. Funds are electronically transferred by CTS for ease and speed. Upon completion of a project, the user's feedback regarding project participants can be input into a nationwide database of contractors, accessible by other users. CTS an instant messaging tool for the project and the nationwide construction community. CTS can provide advantages compared to other systems. These advantages can include a cost effective solution to project management, the ability to work on multiple projects, construction material discounts, savings on back office staffing for contractors, financial lines of credit and the ability to advertise the user's company nationwide.

By utilizing an easy-to-use and flexible user-friendly interface, CTS automates and stream line the flow of information, legal and insurance documents, project costing and milestone funding between the general contractors, sub trades, suppliers and property owners. Utilizing CTS, all parties are able to protect themselves legally, as well as monitor all project costs, invoice and fund in real time and able the contractors to accurately project cash flow. The system automatically validates the contractor's license, avoiding penalties and fines later on. Each functionality of the CTS software is created with the utmost in simplicity for the user, as well as affordability, building trust for and with the contractor and the construction industry. The CTS manages users, and for each user the system saves user name, password, job title and access level. Access level specifies the user access level to information and actions in the system. Access level can be one of the following: Project administrator, Project Contributor, Reader. The user can choose to save his or her user name and password and role after a successful login. The user can choose at any point to logout from CTS.

A user uses a user device to run the CTS software implementing a workflow automation system for use in the construction industry. The CTS is incorporates visually dynamic and user-friendly interface that standardizes and streamlines the creation and transmission of legal and insurance documents, project costing, invoicing and milestone funding between the contractors, sub trades, suppliers and property owners. The system enables monitoring of all project costs, invoicing and funding in real time, projection of cash flow, and validation of licenses of contractors and sub-contractors.

User devices that can be employed to run the CTS can include suitable computing devices, e.g., a personal computer, a smart phone (e.g., iPhone, Google phone, or other phones running Android, Window Mobile, or other operating systems), a tablet computer (e.g., iPad, Galaxy), personal digital assistant (PDA), a notebook computer, or various other types of wireless or wired computing devices. The user device can communicate over a network. The network can be implemented as a single network or a combination of multiple networks. For example, in various embodiments, the network can include the Internet and/or one or more intranets, wireless networks (e.g., cellular, wide area network (WAN), WIFI hot spot, personal area network (PAN), Bluetooth), landline networks and/or other appropriate types of communication networks. As such, in various embodiments, the user device may be associated with a particular link (e.g., a link, such as a URL (Uniform Resource Locator) to an IP (Internet Protocol) address).

The CTS can be provided in different versions. For example, a residential version can be provided, or a full commercial version can be provided. Alternatively, versions can be provided that have state information that accounts for the preliminary lien notice laws of various states and enables the licenses of participating contractors in different states to be verified. The system can provide each party involved in the construction process (e.g., contractor, subcontractor, supplier, customer, etc.) the protection they need during the construction process. The CTS can be provided as a stand-alone system, or as a web based product or cloud computing application. Documentation for operating the system can be provided in any suitable format, e.g., CD, book, or website version.

Customer support can be provided as part of the CTS, e.g., on line or telephone customer support. The customer support can include answering any questions users may have with downloading or features and integration of their accounting or other construction management software into the CTS. Other support can include assisting on financing questions, such as job costing. Features of the CTS that can integrate with customer support can include a job costing “barometer” or “fuel gauge” that allows users to monitor the project costs from their perspective (i.e., owner, general contractor, subcontractor and supplier). A “Milestone System” can be provided that enables monitoring and instituting collections, or a “Net Term” route can be employed such that once invoices have gone out per terms and conditions, emails are generated to confirm receipt, and are continued every two weeks—once terms are passed, collections assistance can be provided if requested. Line of credit assistance can be provided to users (general contractors and sub trades) to insure their payroll is covered through a line of credit, utilizing invoices as collateral.

The CTS can be integrated with QuickBooks financial software, available from Intuit, Inc. of Mountain View, Calif., and Sage Timberline Office Project Management application available from Sage North America of Irvine, Calif. This enables users to use both software programs more effectively.

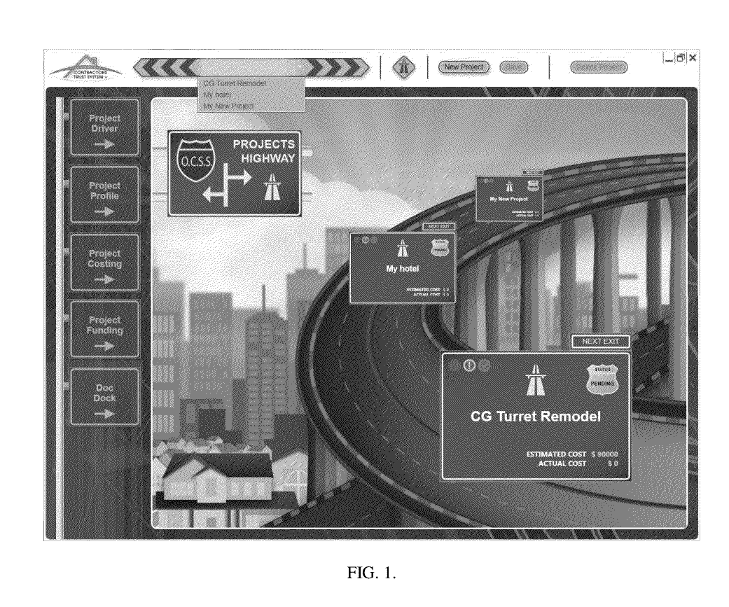

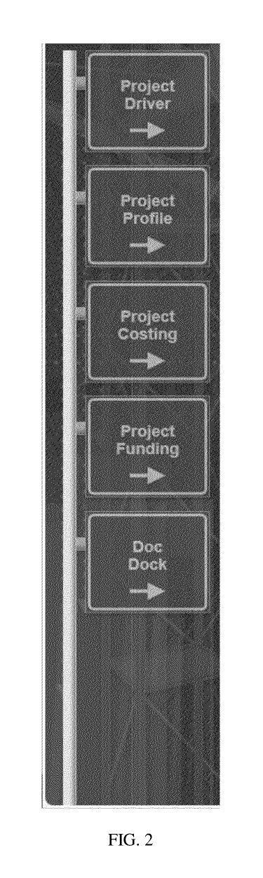

The CTS offers various functionality available through a user-friendly interface. The main screen of the CTS software, or Project Dashboard, depicted in FIG. 1, provides a menu from which a user can navigate to different screens in software. This menu, situated on the left hand side of the screen and depicted in FIG. 2, includes signs or links to a Project Driver, Project Profile, Project Costing, Project Funding, and Doc Dock. At the Project Dashboard screen, CTS displays a list of projects for the current user. For each project displayed at the dashboard, CTS displays the project's name, state and notifications for events that require the user's attention. The user is able to navigate between his or her projects. Once the user selects one project, the Project Profile screen of the selected project is displayed. CTS provides the user the ability to generate reports on the stored information. Predefined reports include Projects by Start time, and Projects by Actual Cost. The generated report can be saved locally as a PDF, printed or emailed.

A user can select the desired project in several ways, including double-clicking on the sign with the name of the project wanted. Alternatively, a user can scroll the cursor with a mouse and select from a box at the top of the screen by using the arrows next to the box.

Menu navigation can be employed between different screens. The Project Driver screen provides various user information. The Project Profile screen displays details of the project. The Project Costing screen provides cost details. The Project Funding screen provides a schedule detailing the deadlines of the various sub projects involved in a larger project. The Doc Dock screen provides a navigation menu allowing relevant documents to be filled automatically by the CTS.

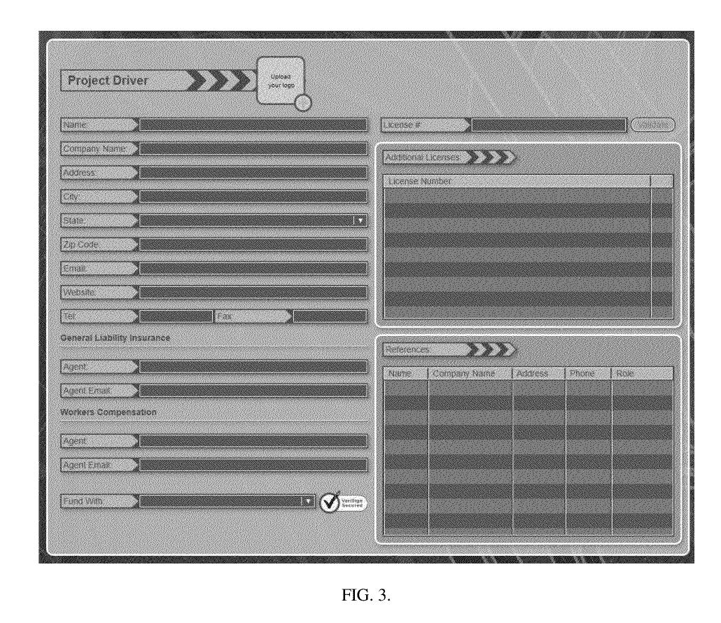

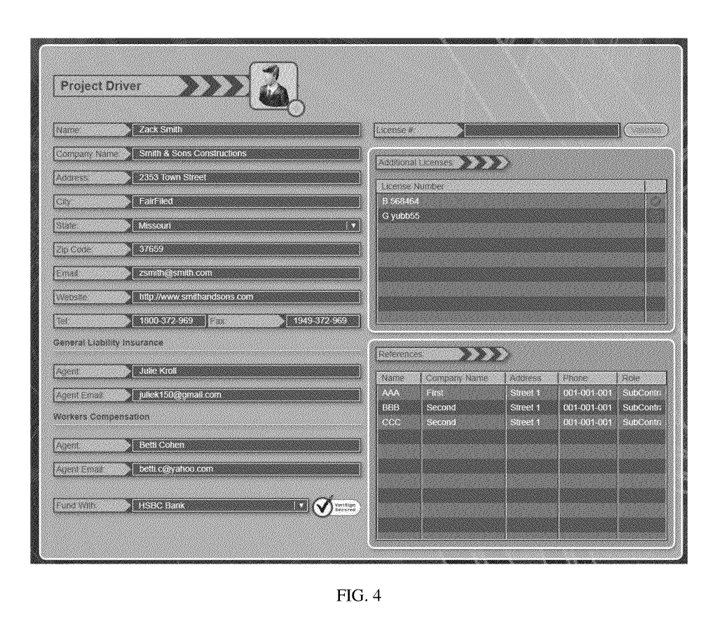

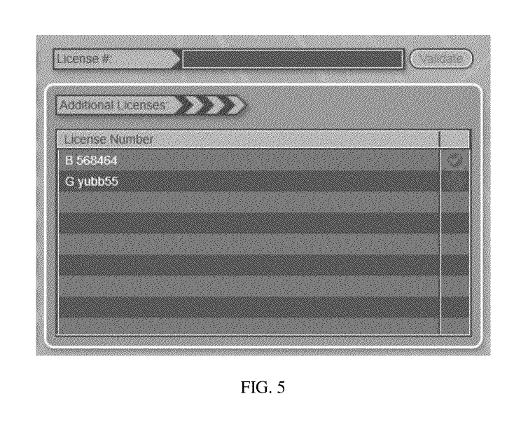

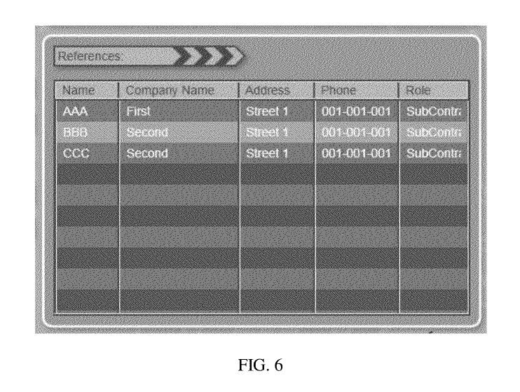

The Project Driver screen is blank upon opening by a user for the first time, as depicted in FIG. 3. This screen enables the user to input personal data. Clicking the Save button on the Options bar at the top of the screen causes the input data to be stored by CTS and does not need to be saved again. The saved data can be updated or supplemented, as necessary, and changes saved. An example of a Project Driver screen including saved data is provided in FIG. 4. This data can include a user name, company name, address, city, state, zip code, email address, website, telephone, fax, agent for the user's general liability insurance and email of same, agent for the user's workers compensation and email and funding source of same. Information regarding professional licenses can be entered (FIG. 5), along with professional references (including name, company name, address, phone, and their role) (FIG. 6). The user's company logo, user's photo or other image can also be uploaded.

License information can be validated with the applicable government agencies by clicking the Validate link. The CTS links to the licensing entity's website, or a database containing current licensing information, and verifies the current status of the license information. As depicted in FIG. 5, a green check next to the license information indicates that the license is verified as current and a red X next to the license information indicates that the license was not able to be verified (e.g., lapsed, typographical error in license number, or other issue). For license information not verified as current, the user or customer service provider can investigate further to determine if a data entry issue is responsible for the failure to validate or if the purported licensee is actually not licensed. CTS generates a reminder for each license entered to remind the user to renew his or her license at the state board. The information entered auto populates the necessary legal and financial documents.

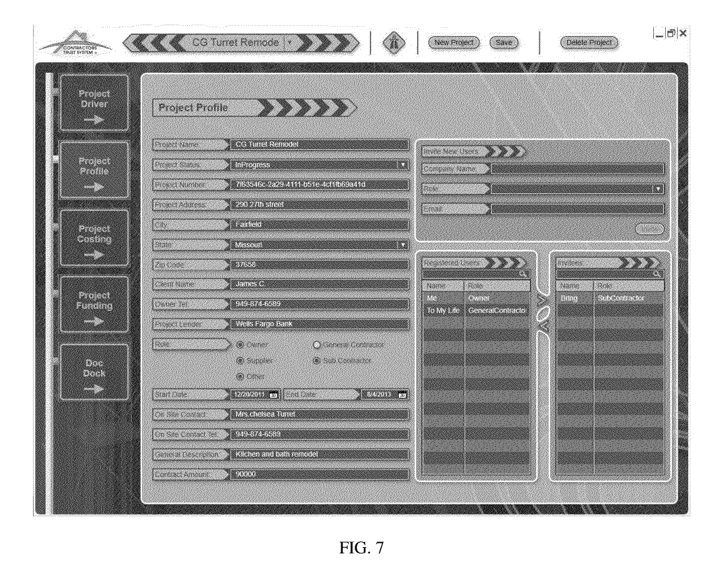

As shown in FIG. 7, the Project Profile screen is a screen which has all information about the selected project. This is the screen shown after selecting the project by clicking from a list of saved projects on the Options bar. The information displayed includes the project name, project status, project number, project address, city, state, zip code, client name, owner telephone, project lender, the user role (owner, general contractor, supplier, subcontractor, or other), the start date, the end date, the on-site contact name, the on-site contact telephone number, a general description of the project, and a contract amount (U.S. dollars or other currency). CTS auto generates a project number, and the generated number is unique. This unique number identifies the project in the CTS database. CTS enables a user to invite clients, subcontractors and vendors to download the CTS System or to search the CTS database for their information if they already registered. If one of the invitees has not renewed his or her state license, a notification appears near his or her name. The notification appears near every related screen and document (for example, near a payable for this user). The information entered auto populates the necessary legal and financial documents.

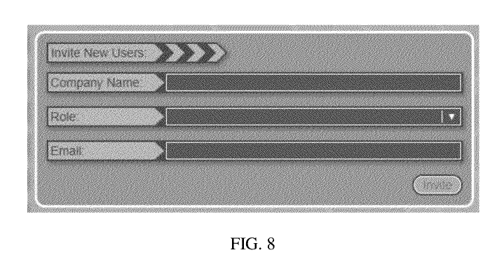

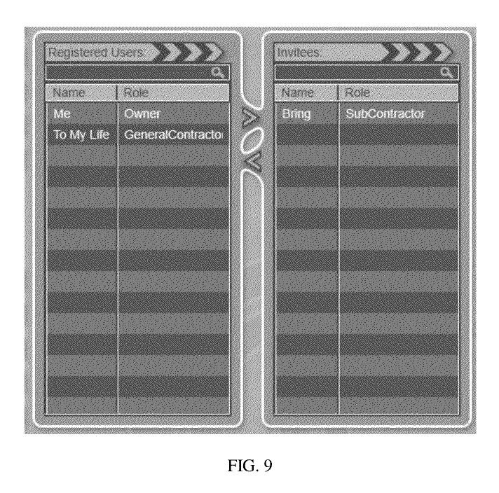

The interface permits invitation of new users by inputting company name, role, and email, as depicted in FIG. 8. The CTS enables the user to order a new user to the project by sending an email request for joining the project. Invitees can be added to a project by clicking between the Registered Users and Invitees displays, as depicted in FIG. 9. A search box is provided to enable searching of registered users and invitees.

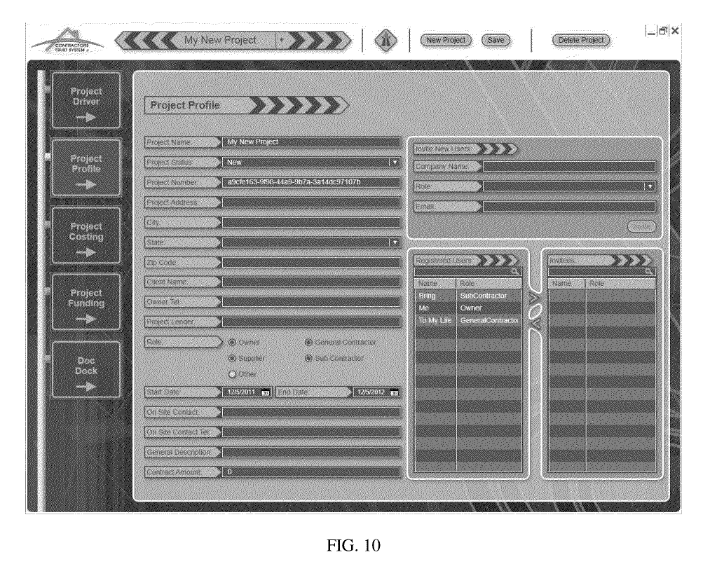

The screen, depicted in FIG. 10, appears when the data are reset and the user has filled in data for a project. Data can be saved by clicking a button on the Options toolbar. The data is stored by the CTS and generates a document including the data.

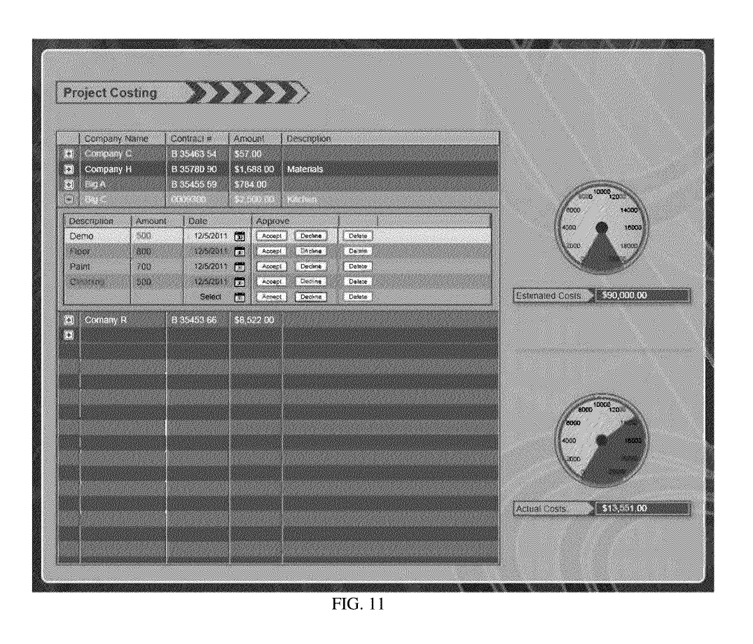

The Project Costing screen, as shown in FIG. 11, provides detailed cost information for companies involved in the project (company name, contract number, amount, and description). For a particular company, details of each separate aspect of the contract are provided, including a description of the work (e.g., demolition, floor, paint, cleaning), the amount, and the date can be accessed by expanding on the company entry. The separate aspects can be individually accepted, declined, or deleted by clicking the applicable button, as shown in FIG. 11. Graphical depictions, similar to a gauge, dial, barometer or meter, depicting the degree of accrual of estimated costs and actual costs are provided adjacent to the company entries, and provide a readily ascertainable snapshot of costing information. Change orders can be incorporated into the overall budget immediately. For each contract, the user can edit a sub data grid where he can enter his: Material, Labor, Rentals, Misc., Sub Total, P&O, and/or the like. CTS automatically sums all the values to a total amount. A Subs Contractors grid is provided where all contracts and schedule values from the sub-contractors are uploaded. For each contract, the user can see the contract number, contract total amount and description. When the user selects a contract, CTS displays a sub grid with the related schedule of values. On the fuel gauge, CTS displays all project costs and the user's budget in real time. CTS enables the user to accept or decline a schedule of value. If accepted, CTS creates an invoice from the schedule of value and update the system with the newly created invoice. The invoice is submitted at the appropriate time. A green notification is shown for both parties at the relevant grid. If declined, a red notification is displayed at both parties at the applicable grid. The information auto populates the necessary legal and financial documents.

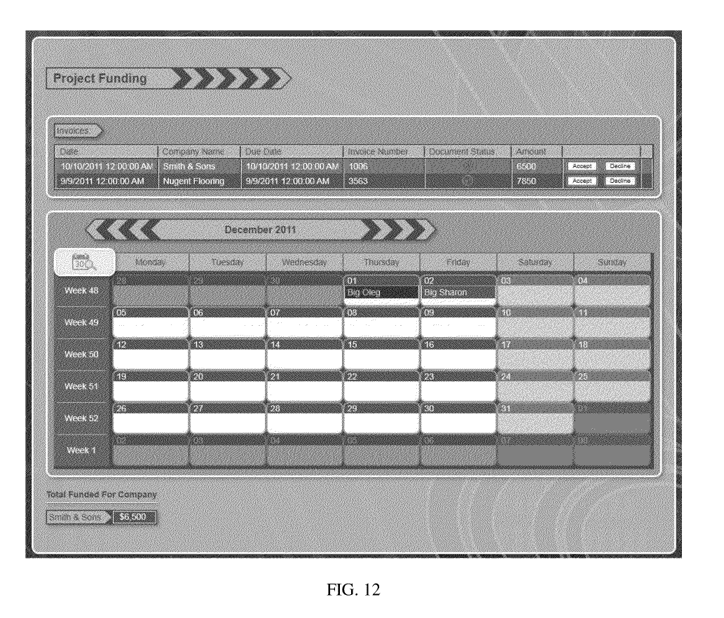

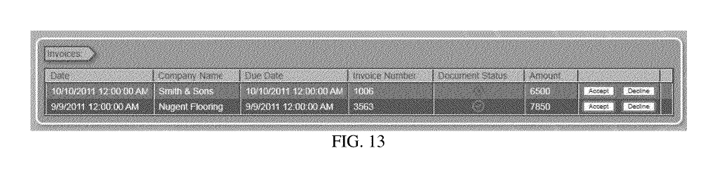

The Project Funding screen, depicted in FIG. 12, provides detailed information regarding account status, including invoice information (date issued, company name, due date, invoice number, document status, and amount). The invoice can be accessed to correct and complete entry of information, then accepted or declined by clicking the applicable button, as depicted in FIG. 13. By clicking “Accept”, the invoice is recorded into the appropriate calendar date as listed in the “Due Date”. By clicking “Decline” the record is removed from the table. CTS displays all invoices related to the project and enable the user to accept or decline an invoice. Approved invoices are placed on the easy to read calendar affording contractors the ability to project cash flow and alerting clients as to upcoming expenditures. Declined invoices generate a notification at the owner's CTS system. CTS enables the user to export the invoices to his or her preferred accounting software. Invoice payments can be funded electronically. CTS has the ability to integrate with state local accounting government agencies for funding, permitting and licensing.

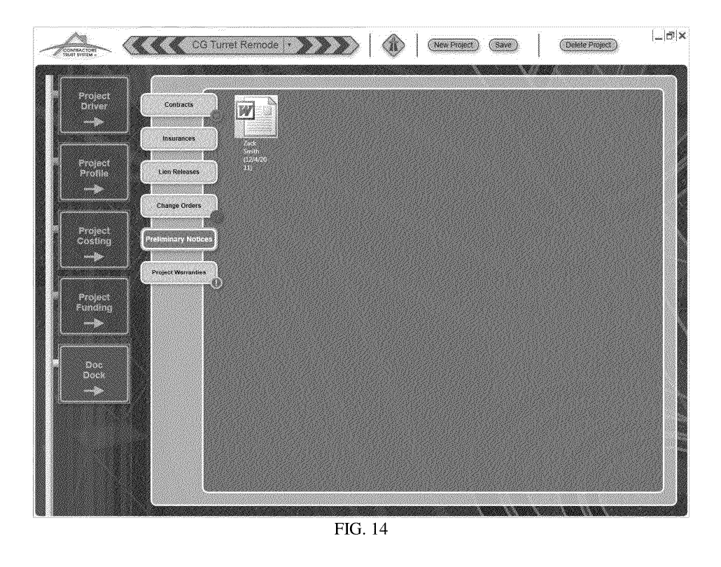

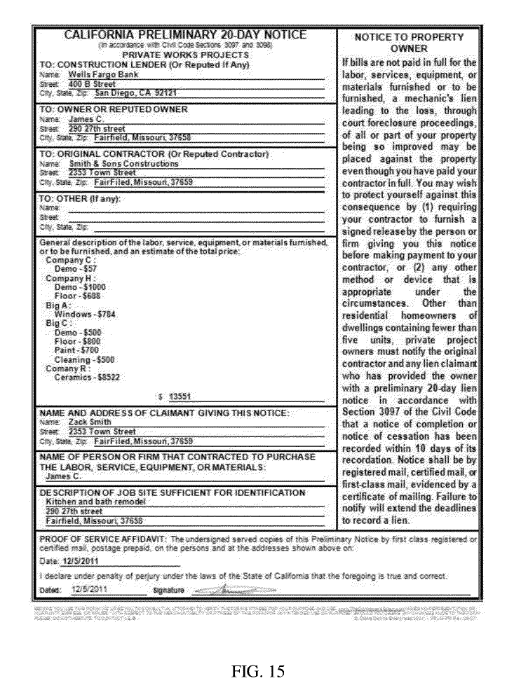

The Doc Dock screen, as depicted in FIG. 14, provides an interface allowing the user to access various documents associated with a project by clicking the applicable box. These documents can include contracts, insurances, lien releases, change orders, preliminary notices, project warranties, pictures, and the like. At Doc Dock, CTS enables the user to upload all his or her project related documents. Doc dock functions as a shared folder where all project participants are able to upload documents that are synchronized to all project participants. At Doc Dock, CTS generates the state specific legal documents required for the user's protection and submits them to the appropriate parties. Clear notifications identify what insurance or releases have not been received (red X or yellow exclamation point), and what has been received (green check). These notifications then propagate to the Project Funding screen near invoices related to these documents. The documents stored can be accessed by clicking on the applicable button, which then causes the stored document to be displayed as a pop-up, as shown in FIG. 15.

In certain embodiments, a Tailgate screen is provided that enables the user to rate each service provider he works with. At Tailgate, CTS presents the user with a map, upon which CTS “pins” suppliers (from data stored in the CTS database) that are located within a specified geographic distance from the project's address. In a similar way, the Tailgate map can display other relevant information for the user. In certain embodiments, CTS provides the user with a wizard screen, which enables the user to quickly fill in all mandatory information from the point of view of his or her role on the project. CTS can provide the user online help for the application, or the ability to contact a customer service representative. In certain embodiments, CTS provides the user the ability to save contact information for each participant in his or her projects. The user has the ability to sort the contacts by project, by name or by address. In certain embodiments, CTS can perform one or more of the following functionalities: export invoices to known accounting software; validate license information with each state board; integrate with state local accounting government agencies for funding, permitting and licensing; and interface with internet mapping technology, e.g., Google maps. Entered data is preferably stored in a CTS database, where it is encrypted. All user banking information is preferably associated with a digital signature.

While the software and methods have been described herein with respect to the construction industry, they are also applicable to other industries wherein project management is a concern. Some exemplary industries include the entertainment industry (concerts, performances, festivals, special events, and the like), hospitality (catering, wedding planning, banquets, conferences, and the like), technical (preparation of prototypes, development of software, product testing, employee training), and the like. The software and methods are especially useful for projects where one or more parties are professionally licensed and/or permits or other documents with government entities are involved. The methods and systems are also well-suited to use in managing projects wherein ease of fund disbursements is desirable, e.g., where many payees are involved.

All references cited herein are incorporated herein by reference in their entirety. To the extent publications and patents or patent applications incorporated by reference contradict the disclosure contained in the specification, the specification is intended to supersede and/or take precedence over any such contradictory material.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as program code and/or data for managing and processing data may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Unless otherwise defined, all terms (including technical and scientific terms) are to be given their ordinary and customary meaning to a person of ordinary skill in the art, and are not to be limited to a special or customized meaning unless expressly so defined herein.

Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Although embodiments of the present disclosure have been described, these embodiments illustrate but do not limit the disclosure. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

What is claimed is:

1. A method for managing a construction project, comprising:
inputting a user's personal data into a contractors trust system, wherein the personal data includes licensing information for a user;
inputting project data into the contractors trust system, wherein the project data includes a contract amount;
inputting cost information for the project;
inputting funding information for the project, wherein the funding information includes approval or declining of an invoice;
saving the inputted data;
verifying license information with a licensing agency;
generating legal documents and automatically submitting them to a preselected party; and
graphically displaying estimated costs and actual costs for the project in real time.

2. The method of claim 1, wherein verifying license information further comprises providing the user confirmation of a valid license.

3. The method of claim 1, further comprising generating a reminder for renewing a user's license with a licensing board, wherein license information has been entered for the license.

4. The method of claim 1, further comprising entering a change order that is immediately incorporated into the estimated costs.

5. The method of claim 1, further comprising creating an invoice based on the cost information and automatically submitting the invoice for payment at a preselected time based on the cost information.

6. The method of claim 1, further comprising submitting an invoice for payment upon approval, whereby automatic electronic payment of the invoice is initiated using financial information included in the personal data.

7. A user device comprising:
a processor; and
a memory adapted to store a plurality of machine-readable instructions which when executed by the processor are adapted to cause the user device to accept input of a user's personal data into a contractors trust system, wherein the personal data includes licensing information for a user; accept input of project data into the contractors trust system, wherein the project data includes a contract amount; accept input of cost information for the project; accept input of funding information for the project, wherein the funding information includes approval or declining of an invoice; save the inputted data; verify license information with a licensing agency; generate legal documents and automatically submit them to a preselected party; and graphically display estimated costs and actual costs for the project in real time.

8. The user device of claim 7, wherein the machine-readable instructions when executed by the processor are adapted to further cause providing the user confirmation of a valid license.

9. The user device of claim 7, wherein the machine-readable instructions when executed by the processor are adapted to further cause generation of a reminder for renewing a user's license with a licensing board, wherein license information has been entered for the license.

10. The user device of claim 7, wherein the machine-readable instructions when executed by the processor are adapted to further cause entry of a change order that is immediately incorporated into the estimated costs.

11. The user device of claim 7, wherein the machine-readable instructions when executed by the processor are adapted to further cause creation of an invoice based on the cost information and automatic submission of the invoice for payment at a preselected time based on the cost information.

12. The user device of claim 7, wherein the machine-readable instructions when executed by the processor are adapted to further cause submission of an invoice for payment upon approval, whereby automatic electronic payment of the invoice is initiated using financial information included in the personal data.

13. A non-transitory computer readable medium having computer readable code for instructing a processor to perform a method, the method comprising:
inputting a user's personal data into a contractors trust system, wherein the personal data includes licensing information for a user;
inputting project data into the contractors trust system, wherein the project data includes a contract amount;
inputting cost information for the project;
inputting funding information for the project, wherein the funding information includes approval or declining of an invoice;
saving the inputted data;
verifying license information with a licensing agency;
generating legal documents and automatically submitting them to a preselected party; and
graphically displaying estimated costs and actual costs for the project in real time.
